(19) United States
(12) Patent Application Publication
(10) Pub. No.: US 2026/0316404 A1
(43) Pub. Date: Oct. 15, 2026

(54) A HOLLOW ROTO-MOULDED ARTICLE

(71) Applicant: OMNI COMPOSITE TANK LIMITED, Hong Kong (CN)

(72) Inventors: Daniel Christopher RODGERS, Sydney, New South Wales (AU); Luke Philip DJUKIC, Sydney, New South Wales (AU); Robert Andrew STUBBS, Sydney, New South Wales (AU)

(21) Appl. No.: 19/100,373

(22) PCT Filed: Aug. 3, 2023
(86) PCT No.: PCT/AU2023/050728

§ 371 Date: Jan. 31, 2025

(30) Foreign Application Priority Data
Aug. 3, 2022 (AU) 2022902178

(51) Int. Cl. B29C 70/32; B29C 41/04; B29C 41/20; B29C 70/36; B29L 31/00; B65D 88/06; B65D 90/02

(52) U.S. Cl. CPC B29C 70/326; B29C 41/042; B29C 41/20; B29C 70/36; B65D 88/06; B65D 90/02; B29L 2031/712

(57) ABSTRACT

A hollow roto-moulded article, having an inner wall defining an interior of the article and integrally formed structure with the inner wall, wherein the integrally formed structure protrudes into the interior of the article, the article formed of a first layer including one or more thermoplastic polymers, and a second layer including one or more fibrous materials.

### FIELD OF THE INVENTION

The present invention generally relates to a rotationally moulded (roto-moulded) article. In particular, embodiments of the invention relate to a hollow composite vessel having at least a thermoplastic layer and a fibrous layer. Aspects of the invention also relate to manufacture of the vessel utilising rotational moulding processes. The vessels may find use in the storage and transportation of powders, liquids, gases and cryogenic substances, particularly hazardous substances.

### BACKGROUND OF THE INVENTION

Tanks are widely used for the transportation of materials such as liquids, gases and powders, both hazardous and non-hazardous. For the transportation of hazardous materials the tanks must meet a number of local and international regulations.

Tanks for the transportation of hazardous materials are generally constructed from metal, which imparts structural strength, and are typically lined with a resilient liner to protect the metal from the corrosive nature of the tank contents.

However, lined metal tanks have a number of disadvantages, including their excessive weight, which increases transportation costs, and the possibility over time that the liner material becomes degraded due to contact with the tank contents, or detached from the inner wall of the metal container, necessitating liner repair or replacement.

In addition, an issue that arises with material transport, particularly when transporting liquid, is that the liquid has inertia and in its fluid state it tends to continue moving in the same direction when the transport vehicle is manoeuvring. During starting, stopping and turns the liquid surges and sloshes in the tank, making the vehicle more difficult to control or unstable and putting significant stress on the walls of the tank. One of the ways this issue is conventionally dealt with is by installing baffle or surge plates inside the tank. This generally involves installation of a baffle into a tank prior to assembly of the tank heads, or installation of the baffle in smaller segments after the tank heads via a manhole or other opening, and then fixing the plates in suitable positions within the tank (e.g. by welding or other mechanical fastening means). These plates provide barriers to movement of the liquid, improve stability and reduce forces exerted on the walls.

It is desirable to provide an improved tank which overcomes or ameliorates one or more of the disadvantages or problems of the prior art described above, or which at least provides an alternative useful choice.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In a first aspect, the present invention provides a hollow roto-moulded article, having an inner wall defining an interior of the article and integrally formed structure with the inner wall, wherein the integrally formed structure protrudes into the interior of the article, the article formed of a first layer including one or more thermoplastic polymers, and a second layer including one or more fibrous materials.

Preferably, the one or more fibrous materials is at least partly infiltrated with the one or more thermoplastic polymers. Thus, an advantageous multilayer structure is produced that includes a substantially thermoplastic inner/first layer, and a substantially fibrous second layer. The fibrous second layer can act as a suitable coupling layer adapted to enable further layers to be formed therewith. The thermoplastic inner layer can act as a barrier layer that is substantially impervious to material contacting the interior of the article. Furthermore, the integrally formed structure of the article is seamlessly integrated into the article with this same multilayer structure. Thus, there are no weld or join lines present between the article and the integrally formed structure.

The roto-moulded article when having only said first and second layers may be referred to herein as a thermoplastic polymer/fibrous material composite (or similar).

In an embodiment, the article includes at least one cavity extending towards the interior of the article. For example, the at least one cavity may extend through an outer wall of the thermoplastic polymer/fibrous material composite. The cavity may be formed in the roto-moulded article by a protruding portion of a mould used to form the integrally formed structure of the roto-moulded article. In such an embodiment, the integrally formed structure is therefore of substantially corresponding shape and configuration as the protrusion of the mould. Furthermore, the cavity may have an internal surface profile that substantially corresponds to an external surface profile of the integrally formed structure.

In an embodiment, reinforcement is disposed in the cavity. The reinforcement may be configured to resist internal and/or external loads experienced by the article, particularly the integrally formed structure, under operational conditions. Examples of internal and external loads that may be experienced include one or more of: differential pressure across wall between the integrally formed structure and an exterior of the article; differential pressure across wall between the integrally formed structure and the interior of the article; loads due to motion of contents (e.g. fluid) within the article resulting from manoeuvring of the article—can apply in the article's axial, radial, transverse, vertical, and/or tangential directions; and loads imparted on the article and the integrally formed structure from external structural supports and other external loading as a result of manoeuvring the article. In one example, the reinforcement is configured to stiffen and/or strengthen the article. Preferably, the reinforcement is configured to stiffen and/or strengthen at least a portion of the integrally formed structure. For example, the reinforcement may be configured to stiffen and/or strengthen a base of the integrally formed structure.

The reinforcement may assume any form suitable to stiffen and/or strengthen the integrally formed structure. In one embodiment, the reinforcement may be a settable material, e.g. a foam or other settable polymer. The settable material may be injected into the cavity and allowed to set. In an alternative embodiment, the article may include a cover connected to the outer wall of the thermoplastic polymer/fibrous material composite that is configured to fluidly seal the cavity, wherein the reinforcement is a pressurised gas injected into the cavity after the cavity has been fluidly sealed by the cover. In a further alternative embodiment, the reinforcement may be a structural skin. The structural skin may be fixed into the cavity by any suitable means, e.g. adhesive.

The stressed skin is preferably formed of one or more fibrous materials wet laid into the cavity. For example, the stressed skin may be a carbon fibre reinforced polymer and core sandwich that has been wet laid into the cavity.

In a further alternative embodiment, the reinforcement may include bracing structure adapted to be connected in the cavity. Preferably, the bracing structure includes a plurality of bracing elements fixed in the cavity and arranged to stiffen and/or strengthen the integrally formed structure. In one embodiment, the plurality of bracing elements are fixedly arranged in spaced apart relation to one another, wherein one or more of the bracing elements extend in a different direction to the other bracing elements. In an embodiment, the one or more bracing elements may extend in a direction that is at an angle relative to the other bracing elements. The angle may be between about 1° and about 90° (e.g. the one or more bracing elements may extend substantially perpendicular to the other bracing elements). Preferably, the plurality of bracing elements are arranged in a substantially lattice framework and are adapted to enable connection of the bracing structure to the cavity. The bracing elements may be of substantially beam-like form. The one or more bracing elements may include an attachment portion formed or fixed along a portion, e.g. one or each longitudinal side, of the one or more bracing elements, the attachment portion shaped to enable connection of the bracing elements to the cavity. In a preferred form, the bracing elements may be formed of wet-lay fibre reinforced polymer (using a suitable thermoset resin). The bracing elements may be fixed using an adhesive (e.g. a thermoset adhesive). The bracing structure may be formed of one or more reinforcing materials, including wood, metal, polymer, and composite material.

In a preferred embodiment, the reinforcement includes the structural skin fixed in the cavity, and the bracing structure fixed to the structural skin. Advantageously, fixing the bracing structure to the structural skin will facilitate better connection of the bracing structure to the cavity. The bracing structure may be fixed to the structural skin using a suitable adhesive.

In an embodiment, the reinforcement may be formed of any combination of reinforcement mentioned above.

The roto-moulded article may include a cover connected to the outer wall of the thermoplastic polymer/fibrous material composite, the cover configured to shield the reinforcement.

In an embodiment, the integrally formed structure protruding into the interior of the article is one or more baffles. The one or more baffles may each be in the form of a plate protruding into the interior of the article. For example, the one or more baffle plates may be in the form of an orifice plate protruding into the interior of the article. In an alternative embodiment, the one or more baffles may each be substantially lobe-shaped and protrude into the interior of the article.

In an embodiment, the integrally formed structure protruding into the interior of the article is arranged to extend in a direction substantially parallel to a longitudinal axis of the article. In one example, the integrally formed structure protruding into the interior of the article is one or more baffles and each of the one or more baffles is arranged to extend in a direction substantially parallel to the longitudinal axis of the article. In another embodiment, the integrally formed structure protruding into the interior of the article is arranged to extend in a direction substantially perpendicular to the longitudinal axis of the article (e.g. extend in a direction substantially parallel to a transverse direction of the article). In one example, the integrally formed structure protruding into the interior of the article is one or more baffles and each of the one or more baffles is arranged to extend in a direction substantially perpendicular to the longitudinal axis of the article. In an embodiment, the integrally formed structure protruding into the interior of the article is arranged to extend in a radial direction of the article. In one example, the integrally formed structure protruding into the interior of the article is one or more baffles and each of the one or more baffles is arranged to extend in the radial direction of the article.

In an embodiment, a plurality of baffles extend into the interior of the article from circumferentially spaced apart locations of the inner wall. In an embodiment, a plurality of baffles extend into the interior of the article from substantially opposed locations of the inner wall. For example, a pair of baffles may extend into the interior of the article from substantially opposed locations of the inner wall. The baffles (or pair of baffles) may be diametrically opposed. Preferably, the plurality of circumferentially spaced apart baffles extend into the interior of the article and towards one another, thereby forming a gap therebetween when the article is viewed in transverse cross section. In other words, the gap is defined as the area that is not covered by baffle(s) when the article is viewed in transverse cross section. In one example, the gap is substantially V-shaped when the article is viewed in transverse cross section. In an embodiment where the article generally extends in a horizontal direction (e.g. parallel to the ground), preferably a narrower end of the V-shaped gap is disposed at a lower end of the article, and a wider end of the V-shaped gap is disposed at an upper end of the article. Preferably, a pair of baffles extend towards one another and form the substantially V-shaped gap therebetween. In an alternative embodiment, the gap is substantially rectangular shaped when the article is viewed in transverse cross-section. In another embodiment, a single baffle may extend into the interior and form a gap when the article is viewed in transverse cross section. For example, when the baffle is in the form of an orifice plate, the gap may be defined by an orifice of the orifice plate.

Alternatively, the gap may be defined by a space between the baffle and the inner wall.

In an embodiment, the gap may define about 5% to about 95% of a total transverse cross-section of the interior. For example, the gap may define between about 5% and about 50% of the total transverse cross-section of the interior, or between about 5% and about 30% of the total transverse cross-section of the interior.

In one embodiment, the plurality of baffles may be disposed substantially symmetrically about an axis perpendicular to the longitudinal axis of the article. For example, a pair of baffles may be disposed substantially symmetrically about the axis perpendicular to the longitudinal axis of the article. In another embodiment, the plurality of baffles may be disposed substantially symmetrically about an axis parallel to the longitudinal axis of the article. For example, a pair of baffles may be disposed substantially symmetrically about the axis parallel to the longitudinal axis of the article. In a further embodiment, the plurality of baffles may be disposed substantially asymmetrically about an axis parallel to the longitudinal axis of the article. For example, a pair of baffles may be disposed substantially asymmetrically about the axis parallel to the longitudinal axis of the article. In yet a further embodiment, the plurality of baffles may be disposed substantially asymmetrically about an axis perpendicular to the longitudinal axis of the article. For example, a pair of baffles may be disposed substantially asymmetrically about the axis perpendicular to the longitudinal axis of the article.

In an embodiment, a plurality of spaced apart baffles are disposed along a length of the article, e.g. spaced along a direction parallel to the longitudinal axis of the article. Preferably a plurality of spaced apart pairs of baffles are disposed along a length of the article. In another embodiment, there is provided a plurality baffles spaced about a perimeter or a circumference of the article.

Whilst various baffle arrangements are described above, it will be appreciated that different baffle arrangements and different baffle shapes may also be employed.

Further, any combination of the above baffle arrangements and/or shapes may be utilised in any given embodiment.

The or each baffle may include a first baffle wall and a second baffle wall each extending from the inner wall of the article into the interior of the article and merging into a baffle tip. The first and second baffle walls may define substantially planar surfaces disposed in a substantially transverse plane of the article (e.g. the first and second baffle walls may be substantially parallel). In an alternative embodiment, the first and second baffle walls may be angled towards one another, thereby defining a substantially U-shaped baffle when the baffle is viewed in transverse cross section. In another embodiment, the first baffle wall and the second baffle wall each extend from the inner wall of the article into the interior of the article and merge into a substantially curved baffle tip. In an alternative embodiment, the first baffle wall and the second baffle wall each extend from the inner wall of the article into the interior of the article and merge into a substantially flat baffle tip.

In another embodiment, the or each baffle includes a tip transition portion between the first baffle wall and the baffle tip and between the second baffle wall and the baffle tip. The tip transition portions are preferably substantially curved, thereby defining a smooth transition profile between the first baffle wall and the baffle tip and between the second baffle wall and the baffle tip. A radius of curvature of the tip transition portions may be in the range of about 2 mm to about 500 mm, or between about 5 mm and about 100 mm. A radius of curvature of the baffle tip, if substantially curved, may be in the range of about 2 mm to about 500 mm, or between about 5 mm and about 100 mm.

In another embodiment, the or each baffle includes base transition portions between the inner wall and a base of the baffle (e.g. between the inner wall and the first baffle wall and between the inner wall and the second baffle wall). Preferably, the base transition portions are substantially curved. A radius of curvature of the base transition portions is preferably in the range of about 2 mm and 500 mm, or between about 5 mm and about 100 mm.

In an embodiment, an external surface profile of the or each baffle is substantially continuous with the inner wall, i.e. a seamless transition between the inner wall of the article, the first wall, the second wall and the baffle tip. In a preferred embodiment, the base transition portions and the tip transition are all substantially curved. Advantageously, in such an embodiment, the roto-moulded article can be more easily formed during rotational moulding due to the provision of suitably curved surface profiles that enable improved contact time between a mould used to form the article and the one or more thermoplastic polymers and the one or more fibrous materials. As a result, a more consistent bond between the one or more fibrous materials and the one or more thermoplastic polymers is achieved.

The or each baffle may define in part a boundary between adjacent compartments of the article. In such an embodiment, the gap is adapted to maintain fluid communication between adjacent compartments of the article.

In an embodiment, the article includes a recess disposed about a periphery of the or each cavity. The recess may extend through the outer wall of the thermoplastic polymer/fibrous material composite. The recess is configured to facilitate engagement of one or more subsequent layers to the first and second layers. For example, the recess may be configured to facilitate engagement between the hollow thermoplastic polymer/fibrous material composite and one or more subsequent layers. The recess and the cavity may be coaxial. The recess preferably includes a base adapted to facilitate engagement of the thermoplastic polymer/fibrous material composite to one or more subsequent layers. The base may include an engagement surface on which at least a portion of the one or more subsequent layers may bear. The engagement surface may be substantially planar. The recess may have a depth between about 1 mm and about 200 mm, or from about 1 mm to about 100 mm, or from about 5 mm to about 50 mm.

The recess may further include a side wall. The side wall preferably tapers inwardly from the outer wall of the thermoplastic polymer/fibrous material composite to the base of the recess. Advantageously, the inwardly tapered side wall facilitates improved introduction and engagement of the one or more subsequent layers with the thermoplastic polymer/fibrous material composite.

The one or more thermoplastic polymers in the first layer may include one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone) and polyamide.

In an embodiment, the one or more fibrous materials of the second layer comprise one or more of ceramic fibres and polymeric fibres.

The one or more ceramic fibres may include one or more of glass, carbon and basalt fibres, or precursors thereof.

The one or more polymeric fibres may comprise one or both synthetic polymers and natural polymers.

The one or more polymeric fibres may comprise one or more of polyamide and polyolefin. Suitable polyolefins include polyethylene and polypropylene.

In an embodiment, the one or more fibrous materials include one or more fabricated textile materials.

The one or more fabricated textile materials may include one or more of woven, knitted, and braided materials.

The one or more fabricated textile materials comprise yarns of plied strands. In an embodiment, the spacing between at least some yarns of the fibrous material of the second layer is from about 0.01 micron to about 5000 micron, or from about 0.1 micron to about 5000 micron, or between about 1 micron and about 5000 micron, or between about 10 micron and about 5000 micron.

In an embodiment, the article includes a third layer including a plurality of filaments selected from one or more of carbon, glass, aramid and basalt filaments, and one or more thermosetting polymers, wherein the second layer is disposed between the first layer and the third layer, and wherein the one or more fibrous materials is at least partly infiltrated with both the one or more thermoplastic polymers and the one or more thermosetting polymers. Preferably, the third layer is provided on an outer side of the outer wall of the thermoplastic polymer/fibrous material composite. In such an embodiment, the plurality of filaments engage with the engagement surface of the recess. In an alternative example, the third layer may be disposed over a cover connected to the cavity.

In another embodiment, the article includes a third layer including a plurality of filaments selected from one or more of carbon, glass, aramid and basalt filaments, and one or more thermosetting polymers, wherein the third layer is manually hand laid onto the second layer, wherein the one or more fibrous materials is at least partly infiltrated with both the one or more thermoplastic polymers and the one or more thermosetting polymers. Preferably, the third layer is provided on an outer side of the outer wall of the thermoplastic polymer/fibrous material composite.

In another embodiment, the article includes a third layer including a plurality of filaments selected from one or more of carbon, glass, aramid and basalt filaments, and one or more thermosetting polymers, wherein the third layer is vacuum infused onto the second layer, wherein the one or more fibrous materials is at least partly infiltrated with both the one or more thermoplastic polymers and the one or more thermosetting polymers. Preferably, the third layer is provided on an outer side of the outer wall of the thermoplastic polymer/fibrous material composite.

In an embodiment, the one or more thermosetting polymers of the third layer comprise one or more of vinyl ester, bismaleimide, polyester, polyacrylate, epoxy, and polyurethane.

In an embodiment, the plurality of filaments of the third layer have a filament diameter from about 0.1 micron to about 500 micron, or from about 0.1 micron to about 100 micron, or from about 0.1 micron to about 50 micron, or from about 1 micron to about 20 micron.

In an embodiment, the plurality of filaments of the third layer are in the form of one or more of wound filaments, fabric sections comprising multiple yarns, braided yarns, and chopped fibres.

In an embodiment, the thickness of the first layer is from about 0.1 mm to about 50 mm, the thickness of the second layer is from about 0.1 mm to about 5 mm, and the thickness of the third layer is from about 0.1 mm to about 1000 mm.

In an embodiment, thermoplastic polymer is embedded in gaps between yarns of the fibrous material of the second layer.

In an embodiment, thermoplastic polymer is embedded within the structure of individual yarns of the fibrous material of the second layer.

In an embodiment, tendrils of the fibrous material of the second layer extend from a surface of the yarns into the first layer.

In an embodiment, the thermoplastic polymer is not completely infiltrated across a thickness of the fibrous layer. That is to say, at least a portion of the surface of the fibrous layer is not fully penetrated by the thermoplastic polymer. Preferably, substantially all of the surface of the fibrous layer is not fully penetrated by the thermoplastic polymer.

In a preferred form, the article is a hollow composite vessel (or thermoplastic polymer/fibrous material composite vessel), and the integral structure is configured to reduce surge forces experienced by the hollow composite vessel in use. The integral structure may further be configured to reduce surge forces experienced by any structure to which the hollow composite vessel is affixed.

The hollow composite vessel (or thermoplastic polymer/fibrous material composite vessel) may be of generally spherical, cylindrical, spherocylindrical, rectangular, or any other shape generally known in the art.

In a second aspect, the present invention provides a method of producing a hollow composite vessel, the method including:
applying one or more fibrous materials to an internal surface of a hollow mould, the hollow mould including structure protruding into an interior of the mould;
heating and rotating the hollow mould in the presence of one or more thermoplastic polymers within the hollow mould so that the polymer melts and at least partially infiltrates the fibrous material;
cooling the mould so that the thermoplastic polymer solidifies; and
releasing a hollow thermoplastic polymer/fibrous material composite vessel having integrally formed structure protruding into an interior of the vessel from the mould.

Advantageously, the present invention enables the production of a hollow composite vessel having a substantially thermoplastic inner/first layer, with a substantially fibrous second layer. The fibrous second layer can act as a suitable coupling layer adapted to enable further layers to be formed therewith. The thermoplastic inner layer can act as a barrier layer that is substantially impervious to material contacting the interior of the vessel. Furthermore, the integrally formed structure of the vessel is seamlessly integrated into the vessel with this same multilayer structure. Thus, there are no weld or join lines present between the vessel and the integrally formed structure.

It is to be understood that reference to the thermoplastic polymer/fibrous material composite vessel is a reference to the hollow composite vessel when having only said fibrous material(s) and thermoplastic polymer(s) layers.

In an embodiment, the method further includes one or more of the following:
applying a plurality of filaments selected from one or more of carbon, glass, aramid and basalt filaments to the outside of the hollow thermoplastic polymer/fibrous material composite vessel wherein prior to application the plurality of filaments are at least partly wetted with one or more thermosetting polymers;
applying a plurality of filaments selected from one or more of carbon, glass, aramid and basalt filaments to the outside of the hollow thermoplastic polymer/fibrous material composite vessel followed by application of one or more thermosetting polymers;
applying one or more thermosetting polymers to the outside of the hollow thermoplastic polymer/fibrous material composite vessel followed by application of a plurality of filaments selected from one or more of carbon, glass, aramid and basalt filaments.

Advantageously, the provision of this additional layer(s) to the outside of the hollow thermoplastic polymer/fibrous material composite vessel results in increased strength of the hollow composite vessel. The fibrous layer of the hollow thermoplastic polymer/fibrous material composite vessel facilitates coupling of this additional layer(s) thereto. Preferably, application of this additional layer(s) results in the one or more fibrous materials being at least partly infiltrated with both the one or more thermoplastic polymers and the one or more thermosetting polymers.

In an embodiment, said applying one or more fibrous materials to an internal surface of a hollow mould includes fastening the one or more fibrous materials to the internal surface of the hollow mould. The hollow mould may include fastening means (e.g. a fastening arrangement) to secure the one or more fibrous materials to the internal surface of the hollow mould. In an embodiment, the method further includes holding the one or more fibrous materials to the internal surface of a hollow mould whilst heating and rotating the hollow mould. For example, gas pressure may be used to hold the one or more fibrous materials to the internal surface of the hollow mould. This may be achieved by supplying a gas flow into an interior of a rotational moulding apparatus (where heating and rotating the hollow mould takes place), thereby applying a pressure differential across the one or more fibrous materials to force the one or more fibrous materials against the internal surface of the hollow mould. In an embodiment, a combination of gas pressure and a fastening arrangement may be employed to secure the one or more fibrous materials to the internal surface of the hollow mould.

Applying one or more fibrous materials to an internal surface of a hollow mould may include applying one or more of ceramic fibres and polymeric fibres. Said applying one or more ceramic fibres may include applying one or more of glass, carbon and basalt fibres, or precursors thereof. Said applying one or more polymeric fibres may include applying one or both synthetic polymers and natural polymers. The one or more polymeric fibres may comprise one or more of polyamide and polyolefin. Suitable polyolefins include polyethylene and polypropylene.

In an embodiment, applying one or more fibrous materials to an internal surface of a hollow mould includes applying a first fibrous material to an internal surface of the hollow mould, and applying a second fibrous material to the first fibrous material.

The one or more thermoplastic polymers may include one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone) and polyamide. The one or more thermoplastic polymers are preferably provided in powder form.

In an embodiment, the one or more fibrous materials include one or more fabricated textile materials. The one or more fabricated textile materials may include one or more of woven, knitted, and braided materials. The one or more fabricated textile materials comprise yarns of plied strands. In an embodiment, the spacing between at least some yarns of the fibrous material is from about 0.01 micron to about 5000 micron, or from about 0.1 micron to about 5000 micron, or between about 1 micron and about 5000 micron, or between about 10 micron and about 5000 micron.

The one or more thermosetting polymers may include one or more of vinyl ester, bismaleimide, polyester, polyacrylate, epoxy, and polyurethane.

In an embodiment, the plurality of filaments have a filament diameter from about 0.1 micron to about 500 micron, or from about 0.1 micron to about 100 micron, or from about 0.1 micron to about 50 micron, or from about 1 micron to about 20 micron.

In an embodiment, the plurality of filaments are in the form of one or more of wound filaments, fabric sections comprising multiple yarns, braided yarns, and chopped fibres.

In an embodiment, the thickness of the first layer is from about 0.1 mm to about 50 mm, the thickness of the second layer is from about 0.1 mm to about 5 mm, and the thickness of the additional layer(s) is from about 0.1 mm to about 1000 mm.

In an embodiment, thermoplastic polymer is embedded in gaps between yarns of the fibrous material of the second layer.

In an embodiment, thermoplastic polymer is embedded within the structure of individual yarns of the fibrous material of the second layer.

In an embodiment, tendrils of the fibrous material of the second layer extend from a surface of the yarns into the first layer.

In an embodiment, the thermoplastic polymer is not completely infiltrated across a thickness of the fibrous layer. That is to say, at least a portion of the surface of the fibrous layer is not fully penetrated by the thermoplastic polymer. Preferably, substantially all of the surface of the fibrous layer is not fully penetrated by the thermoplastic polymer.

In an embodiment, the structure of the hollow mould protruding into the interior of the mould is one or more baffle mould portions each adapted to produce a cavity of substantially the same form in the hollow composite vessel (particularly the hollow thermoplastic polymer/fibrous material composite vessel) and thereby the integrally formed structure protruding into the interior of the vessel, which in this embodiment is one or more baffles.

In an embodiment, the method includes reinforcing the integrally formed structure protruding into an interior of the vessel, e.g. reinforcing the or each baffle. Preferably, reinforcing the or each baffle occurs before applying additional layer(s) to the hollow thermoplastic polymer/fibrous material composite vessel. Preferably, reinforcing the or each baffle includes inserting reinforcement into each cavity. The reinforcement may assume any form suitable to stiffen and/or strengthen the baffle. In one embodiment, the reinforcement may be a settable material, e.g. a foam or other settable polymer. The settable material may be injected into the cavity and allowed to set. In an alternative embodiment, the method includes covering the cavity to fluidly seal the cavity from an external environment of the vessel, and injecting a pressurised gas injected into the sealed cavity. In a further embodiment, reinforcing the or each baffle includes inserting a structural skin into each cavity.

In another embodiment, reinforcing the or each baffle includes inserting bracing structure into each cavity. The bracing structure may include a plurality of bracing elements fixed in the cavity and arranged to stiffen and/or strengthen the baffle. The method may include forming the bracing structure by fixedly arranging the plurality of bracing elements to one another, followed by inserting and fixing the bracing structure into each cavity.

In an embodiment, reinforcing the or each baffle includes inserting any combination of reinforcement mentioned above into each cavity.

In an embodiment, the method further includes forming a recess in an outer wall of the hollow thermoplastic polymer/fibrous material composite vessel about a periphery of the cavity. The hollow mould may include a protrusion disposed about a periphery of the structure protruding into an interior of the mould, thereby forming said recess extending through the outer wall of the hollow thermoplastic polymer/fibrous material composite vessel. Alternatively, said recess may be formed after the hollow thermoplastic polymer/fibrous material composite vessel is released from the mould.

It will be appreciated that the second aspect of the invention can include any of the features defined with respect to the first aspect of the invention.

In a third aspect, the present invention provides a hollow composite vessel, having an inner wall defining an interior of the vessel and integrally formed structure with the inner wall, wherein the integrally formed structure protrudes into the interior of the vessel, the vessel formed of a first layer including one or more thermoplastic polymers, and a second layer including one or more fibrous materials.

It will be appreciated that the third aspect of the invention can include any of the features defined with respect to the first and second aspects of the invention.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 shows a perspective view of a hollow composite vessel in accordance with an embodiment of the present invention;

FIG. 2 shows a perspective partial view of the hollow composite vessel of FIG. 1, with part of the vessel wall hidden to show some of the underlying structure;

FIG. 3 is a transverse cross section view of the hollow composite vessel of FIG. 1 showing a pair of baffles therein;

FIG. 4 shows a perspective partial view (along with a zoomed in view) of the hollow composite vessel of FIG. 1, with part of the vessel wall hidden to show some of the underlying structure, which includes baffle reinforcement structure;

FIG. 5 shows a perspective view of bracing structure in accordance with an embodiment of the invention;

FIG. 6 shows a transverse cross section view of a baffle of the vessel of FIG. 1, in particular showing a multilayer structure of the vessel;

FIG. 7 shows a transverse cross section view of an alternative baffle, in particular showing a multilayer structure of the vessel;

FIG. 8 shows a transverse cross section view of another alternative baffle, in particular showing a multilayer structure of the vessel;

FIG. 9 is a transverse cross section view of another hollow composite vessel showing a pair of baffles therein;

FIG. 10 is a transverse cross section view of another hollow composite vessel showing a group of four baffles therein;

FIG. 11 is a transverse cross section view of another hollow composite vessel showing an orifice plate therein;

FIG. 12 is a transverse cross section view of another hollow composite vessel showing a pair of baffles therein extending in a longitudinal direction of the vessel; and

FIG. 13 shows a perspective partial view of the hollow composite vessel of FIG. 12, with part of the vessel wall hidden to show some of the underlying structure.

### DETAILED DESCRIPTION OF THE EMBODIMENTS

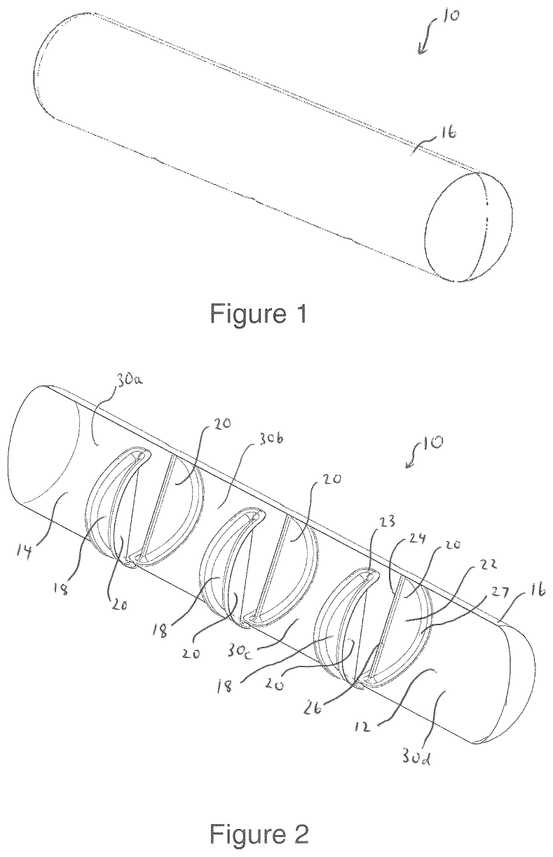

Reference is made to FIG. 1, which depicts a roto-moulded article, in the form of a hollow composite vessel 10. As will be appreciated from the discussion below, vessel 10 is suitable for use in the containing and transporting of hazardous materials including chemicals and the like. However, it will be readily appreciated that vessel 10 can be used for containing and transporting non-dangerous goods, as well as being employed in analogous sectors such as construction of fuel and cargo tanks for transport vehicles, and in aerospace applications.

As will be described in further detail below, vessel 10 is formed in part by a rotational moulding process which, in the case of vessel 10, results in the formation of a multilayer structured vessel. As used herein, reference to a hollow thermoplastic polymer/fibrous material composite vessel (or similar) is a reference to the vessel produced as a direct result of a rotational moulding process, whilst reference to the hollow composite vessel (or similar) may in addition include reference to a modified form of the hollow thermoplastic polymer/fibrous material composite vessel. For example, in certain applications, additional layers are added after the rotational moulding process to the hollow thermoplastic polymer/fibrous material composite vessel in order to make the vessel suitable for such applications. Thus, for avoidance of doubt, hollow composite vessel 10 includes additional layer(s) that have been added to the hollow thermoplastic polymer/fibrous material composite vessel after the rotational moulding process. The multilayer structure will be described in further detail below.

In the depicted embodiment, vessel 10 is of substantially spherocylindrical shape. However, alternative vessel shapes may also be provided, such as cylindrical, rectangular, or any other shape generally known in the art.

Reference is now made to the partial section view of FIG. 2, where one half of vessel outer wall 16 is removed, but internal structure related to said half of the wall remain for explanatory purposes. Vessel 10 includes an inner wall 12 defining an interior 14 of the vessel 10. Vessel 10 further includes integrally formed structure with the inner wall 12 in the form of a plurality of substantially lobe-shaped baffles 20 protruding into the interior 14 of the vessel 10. Baffles 20 are provided to reduce the effect of surge forces that can be caused by movement of contents contained within the vessel 10 during transport. Such surge forces can make a vehicle carrying vessel 10 more difficult to control, as well as putting significant stress on the walls of vessel 10. Baffles 20 thus provide obstructions to movement (in this example, movement in a direction generally parallel to a longitudinal axis of the vessel) of the contents contained in vessel 10, and significantly reduces the force exerted on the vessel walls during turning, stopping and starting of the vehicle.

As shown in FIG. 2, three spaced apart pairs of opposing baffles 20 extend into the interior 14 of the vessel 10. However, it will be appreciated that different baffle arrangements, different baffle shapes and a different number of baffles may also be employed. Baffles 20 are formed by correspondingly shaped structure of a baffle mould (not shown) used to form vessel 10. As a consequence of the formation of baffles 20 by correspondingly shaped structure of the baffle mould, a cavity 18 is formed in an outer wall of the hollow thermoplastic polymer/fibrous material composite vessel formed in the rotational moulding process.

Each baffle 20 includes a first baffle wall 22 extending towards interior 14 from inner wall 12 and a second baffle wall 24 extending towards interior 14 from inner wall 12. The first and second baffle walls 22, 24 define substantially planar surfaces angled slightly towards one another with respect to a baffle longitudinal axis. Thus, the baffle is of substantially U-shape when viewed in transverse cross section. The first and second baffle walls 22, 24 extending into the interior 14 of the vessel 10 smoothly merge into a substantially curved baffle tip 26 by way of substantially curved tip transition portions 25 (best shown in FIG. 6) disposed between first baffle wall 22 and the baffle tip 26 and between second baffle wall 24 and baffle tip 26. A radius of curvature of the tip transition portions 25 may be in the range of about 2 mm to about 500 mm. This curvature of tip transition portions 25 is an important feature in enhancing the manufacturability of vessel 10 with integrally formed baffles 20. One of the challenges of manufacturing vessel 10 is ensuring that during the rotational moulding process, there is sufficient contact time between the thermoplastic polymer(s) and the fibrous material(s) across the entire hollow mould. As rotationally moulding a multilayer structure of complex shape presents many challenges, providing the hollow mould with correspondingly shaped portions to the substantially curved tip transition portions 25 enhances the contact time between the thermoplastic polymer(s) and the fibrous material(s) around this complex portion of the mould.

At a base 23 of each baffle 20 is provided a smooth, substantially curved base transition portion 27 (best shown in FIG. 6) between inner wall 12 and the first baffle wall 22 and between inner wall 12 and second baffle wall 24. Similar to tip transition portions 25, provision of substantially curved base transition portions 27 between the inner wall 12 and the first baffle wall 22 and between the inner wall 12 and second baffle wall 24 are important in facilitating suitable formation of baffles 20 in a rotational moulding process. Significant discontinuities in surface shape, such as sharp corners and bends, increase the complexity of producing vessel 10 with integrally formed structure such as baffles 20 with the requisite structural integrity. Thus, it is most preferable that an external surface profile 21 of baffles 20 is substantially continuous with the inner wall, i.e. a seamless transition provided between inner wall 12, first and second baffle walls 22, 24 and baffle tip 26.

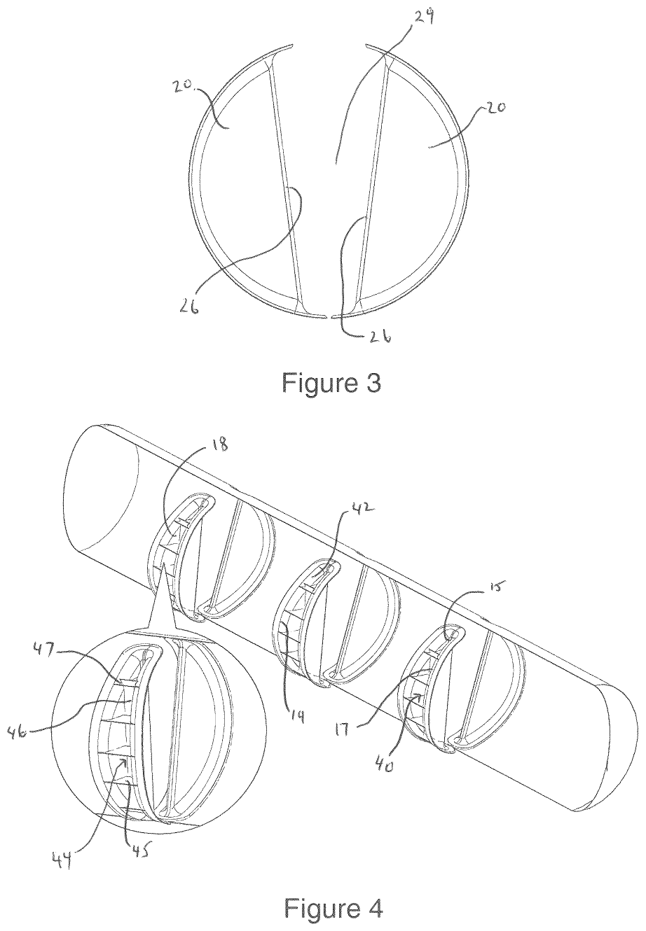

Reference is now made to FIG. 3, which provides a transverse cross section view of vessel 10 with particular focus on a pair of baffles 20, which extend into the interior 14 of vessel 10 from substantially opposed locations of inner wall 12. Each baffle 20 extends slightly under half a diameter of interior 14. As a result, a gap 29 between respective tips 26 of the baffles 20 is provided. In the present embodiment, due to the particular arrangement of baffles 20, gap 29 is of substantially V-shape when viewed in transverse cross section, with the narrower end of V-shaped gap 29 being disposed at a lower end of the vessel 10, and a wider end of V-shaped gap 29 being disposed at an upper end of the vessel 10. Providing the wider end of the V-shaped gap 29 at the upper end of vessel 10 is advantageous in applications where the vessel 10 is oriented substantially horizontally (i.e. approximately parallel with the ground), as it improves access to interior 14 of vessel 10 (access generally being provided by a manhole at the top of vessel 10), provides an air gap at the top of vessel 10 to assist in emptying the contents of vessel 10, and ensures that there is greater sloshing loads at a lower point in vessel 10 (i.e. having a centroid of the contents be further down in the vessel).

As will be appreciated from FIG. 2, each baffle 20 defines in part a boundary between adjacent compartments of vessel 10. In the present embodiment, vessel 10 has three pairs of baffles 20, each baffle pair defining in part a boundary between adjacent compartments of vessel 10-there are four compartments 30a, 30b, 30c, 30d in vessel 10. Each gap 29 between each pair of baffles 20 is adapted to maintain fluid communication between adjacent compartments of the vessel 10.

With reference to FIG. 4, baffles 20 are reinforced with suitable reinforcing structure 40 installed inside cavities 18 of vessel 10. The reinforcement is configured to resist internal and external loads experienced by the vessel 10, particularly the baffles 20, under operational loads. In particular, the reinforcement is configured to stiffen and/or strengthen baffle 20.

As is the case with baffles 20, cavities 18 are of substantially U-shape in transverse cross section and are defined by a first exterior baffle wall 17 (being the exterior of first baffle wall 22), a second exterior baffle wall 19 (being the exterior of second baffle wall 24) and a substantially curved exterior wall 15 (being the exterior of baffle tip 26). In the present embodiment, reinforcing structure 40 includes a structural skin 42 that is formed of an intermediate strength carbon fibre reinforced polymer and core sandwich that is wet laid into each cavity 18. In particular, the structural skin 42 is applied along a substantial portion of the cavity interior, i.e. along first exterior baffle wall 17, second exterior baffle wall 19 and the exterior wall 15.

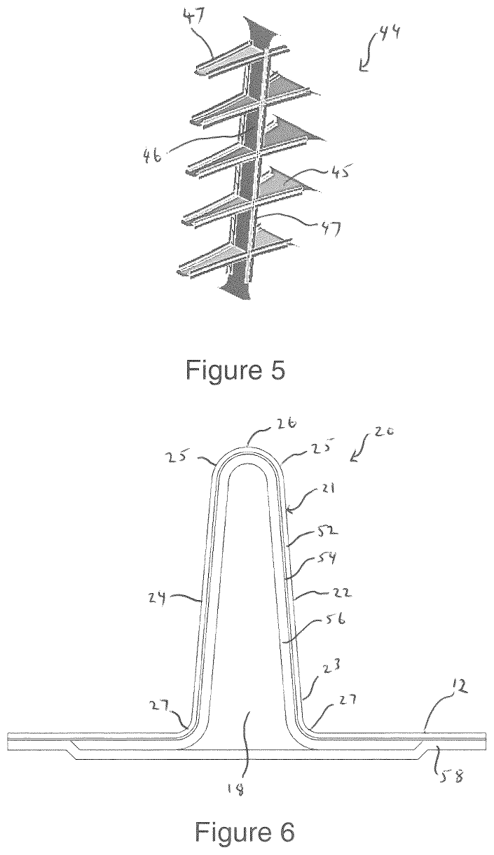

Whilst for some applications, structural skin 42 alone may be sufficient to provide the necessary reinforcement of baffles 20 to withstand operational loads, in the present embodiment, structural skin 42 in addition facilitates the connection of bracing structure 44 into cavity 18. As best shown in the close-up view of cavity 18 in FIG. 4, bracing structure 44 includes a plurality of bracing elements fixed in cavity 18 to stiffen and/or strengthen baffle 20. The bracing elements include a plurality of first bracing beams 45 oriented substantially perpendicular to baffle tip 26 and extending between first exterior baffle wall 17 and second exterior baffle wall 19, a plurality of second bracing beams 46 oriented substantially parallel to baffle tip 26 and extending in a direction substantially perpendicular to beams 45, and cleats 47 fixed along each longitudinal side of beams 45 and 46, the cleats 47 shaped to enable connection of beams 45, 46 to cavity 18. Beams 45, 46 and cleats 47 are formed of wet-lay carbon fibre (using a suitable thermoset resin) and are fixed to structural skin 42 using an adhesive. Whilst each of beams 45, 46 may be individually connected to structural skin 42 (thereby forming bracing structure 44), it is preferred that bracing structure 44 be pre-formed (or in part pre-formed) by fixedly arranging a plurality of beams 45 in spaced apart relation to one or more beams 46 (each of beams 45, 46 already having cleats 47 formed or fixed therewith), thereby forming one or more bracing structures 44 that can then be installed in cavities 18. One example of a suitable pre-formed bracing structure is shown in FIG. 5. After installation of bracing structure 44 into cavities 18, the cavities can then be closed by a cover (not shown), which is connected to the outer wall of the hollow thermoplastic polymer/fibrous material composite vessel and configured to shield the reinforcement and provide a consistent external profile for the hollow thermoplastic polymer/fibrous material composite vessel. However, in other embodiments, a cover may not be used.

Whilst the depicted embodiment of bracing structure 44 is substantially in the form of a lattice framework with beams 45, 46 arranged substantially perpendicular to one another, it will be appreciated that bracing structure 44 can assume many other different arrangements. Further, whilst reinforcing structure 40 in the present embodiment is provided as a combination of structural skin 42 and bracing structure 44, this need not be the case. In other embodiments, the reinforcement structure may be a settable material, e.g. a foam or other settable polymer, which has been injected into cavity 18 and allowed to set. In an alternative embodiment, rather than using reinforcement structure per se, the cavity 18 may be reinforced by injecting pressurised gas therein (after fluidly sealing the cavity with a suitable cover).

With reference to FIG. 6, vessel 10 is formed of a multilayer structure including a first, inner layer 52 including one or more thermoplastic polymers, and a second layer 54 including one or more fibrous materials. As a result of a rotational moulding process, which is explained in more detail below, the one or more fibrous materials are at least partly infiltrated with the one or more thermoplastic polymers. The thermoplastic polymer inner layer 52 acts as a barrier layer that is substantially impervious to material contacting inner layer 52, whilst the fibrous second layer 54 acts as a suitable coupling layer adapted to enable further layers to be formed therewith. Furthermore, baffles 20 of vessel 10 are seamlessly integrated into vessel 10 with the same multilayer structure having the first and second layers. Thus, there are no weld lines present between vessel 10 and baffles 20.

Thermoplastic polymers for use in the construction of first layer 52 preferably possess resistance to a variety of substances and conditions. For example, resistance to one or more of high pH, low pH, oxidising agents, reducing agents, solvents, high pressure gas, cryogenic substances, permeation, and abrasion.

The one or more thermoplastic polymers of first layer 52 can include one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone) and polyamide.

Suitable fluoropolymers include one or more of polyvinyl fluoride, polyvinylidene fluoride, polytetrafluorethylene, perfluoroalkoxy alkane, fluorinated ethylene-propylene, ethylene tetrafluoroethylene, ethylene chlorotrifluoroethylene, polyethylenetetrafluoroethylene, and polyethylenechlorotrifluoroethylene.

The one or more fibrous materials of second layer 54 can include one or more of ceramic fibres and polymeric fibres.

Vessel 10 includes reinforcement layers 56, 58 configured to increase the strength and stiffness of vessel 10. Reinforcement layers 56, 58 are applied to the thermoplastic polymer/fibrous material composite vessel in a number of ways. In one example, the reinforcement layers 56, 58 (e.g. a fibre reinforced polymer laminate) can be manually hand laid onto vessel 10. In another example, the reinforcement layers can be vacuum infused. In a further example, the reinforcement layers can involve: (1) filament winding one or more of carbon, glass, aramid and basalt filaments to the outside of the vessel 10 wherein prior to application, the filaments are at least partly wetted with one or more thermoset polymers; (2) filament winding one or more of carbon, glass, aramid and basalt filaments to the outside of the vessel 10 followed by application of one or more thermoset polymers; or (3) applying one or more thermoset polymers to the outside of the vessel 10 followed by filament winding one or more of carbon, glass, aramid and basalt filaments. As a result of applying reinforcement layers 56, 58, the one or more fibrous materials of the second layer 54 is at least partly infiltrated with both the one or more thermoplastic polymers of the first layer 52 and the one or more thermosetting polymers of the reinforcement layers 56, 58.

The one or more thermosetting polymers may include one or more of vinyl ester, bismaleimide, polyester, polyacrylate, epoxy, and polyurethane.

As previously mentioned, there may be many variations to the baffles and overall baffle arrangement mentioned above.

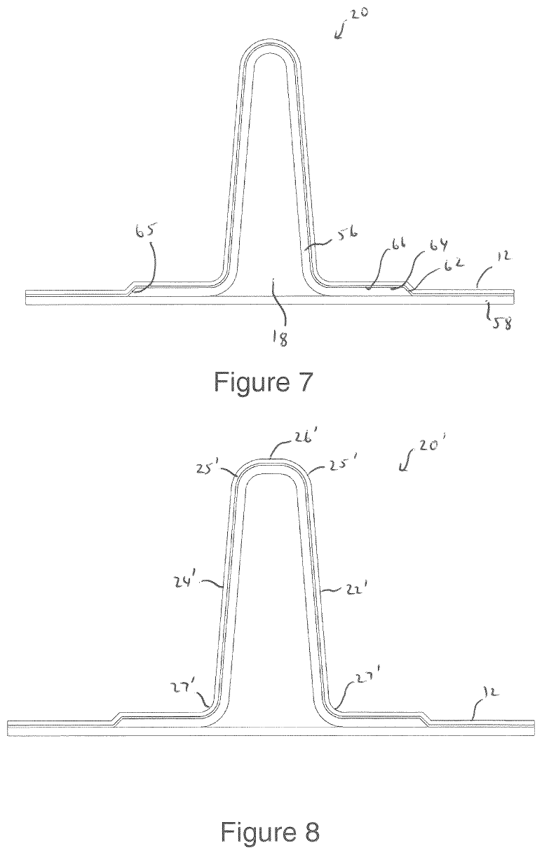

FIG. 7 provides an alternative embodiment, wherein the hollow thermoplastic polymer/fibrous material composite vessel includes an inset 62 provided about a periphery of cavity 18. Inset 62 is configured to facilitate engagement between the hollow thermoplastic polymer/fibrous material composite vessel and one or more reinforcement layers. Inset 62 includes a base 64 adapted to facilitate improved engagement of reinforcement layers 56 to vessel 10, particularly about cavity 18. The base 64 includes a substantially planar engagement surface 66 on which reinforcement layer 56 may bear. Inset 62 further includes a side wall 65 that tapers inwardly from the outer wall of the thermoplastic polymer/fibrous material composite vessel to base 64 of the inset 62. Tapered side wall 65 facilitates improved introduction and engagement of reinforcement layer 65 with the thermoplastic polymer/fibrous material composite vessel. An outermost, reinforcement layer 58 of a fibre reinforced polymer is applied to the whole of the hollow the thermoplastic polymer/fibrous material composite vessel to increase the strength and stiffness of vessel 10. In alternative embodiments, a single reinforcement layer is provided for the whole vessel 10.

FIG. 8 provides a further alternative embodiment, in particular with respect to baffle 20. In this embodiment, relative to the embodiment of FIG. 7, baffle 20′ includes a flat baffle tip 26′. However, it will be appreciated that an external surface profile of baffle 20′ is still substantially continuous with the inner wall 12′, i.e. a seamless transition provided between inner wall 12′, first and second baffle walls 22′, 24′ and baffle tip 26′ due to substantially curved tip transition portions 25′ and substantially curved base transition portions 27′.

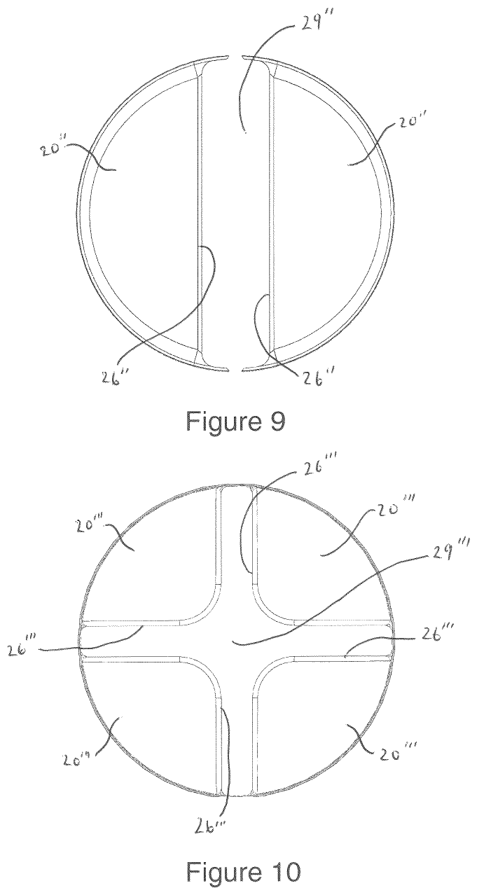

FIG. 9 provides a further alternative embodiment of vessel 10. In this embodiment, a transverse cross section view of vessel 10 reveals a pair of diametrically opposed baffles 20″ extending into the interior 14 of vessel 10. Gap 29″ between respective tips 26″ of the baffles 20″ is substantially rectangular in shape.

FIG. 10 provides a further alternative embodiment of vessel 10. In this embodiment, a transverse cross section view of vessel 10 reveals four circumferentially equispaced baffles 20″′ extending into the interior 14 of vessel 10. Gap 29″′ between respective tips 26″′ of the baffles 20″′ is substantially cross-shaped.

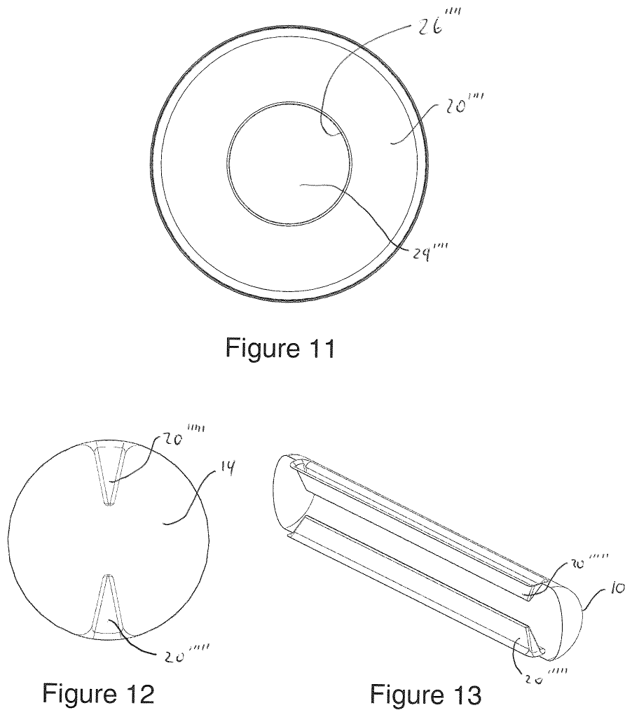

FIG. 11 provides a further alternative embodiment of vessel 10. In this embodiment, a transverse cross section view of vessel 10 reveals a single baffle in the form of an orifice plate 20″″ extending into the interior 14 of vessel 10. Gap 29″″ between a tip 26″″ of orifice plate 20″″ is substantially circular in shape (i.e. the shape of the orifice).

FIGS. 12 and 13 provide a further alternative embodiment of vessel 10. In this embodiment, a transverse cross section view of vessel 10 reveals a pair of diametrically opposed baffles 20″″′ extending into the interior 14 of vessel 10. In this embodiment, baffles 20″″′ extend in a direction substantially parallel to the longitudinal axis of the vessel 10. Such an arrangement may be particularly useful in applications where the vessel 10 is oriented vertically in use (such as in aerospace applications).

### Example Method

One example of a suitable method to produce a hollow composite vessel will now be described. However, it will be appreciated that alternative methods may also be employed.

The method involves preparation of a hollow mould for producing the hollow composite vessel. In the present embodiment, this involves suitable preparation of a plurality of hollow mould elements, which when assembled together form the mould of the whole hollow composite vessel. In the present example, the hollow mould elements include a generally cylindrical section and two end sections of generally hemispherical shape. The generally cylindrical section includes structure protruding into an interior of the mould, said structure in the form of a pair of baffle mould portions. The baffle mould portions may be an integrally formed part of the cylindrical section, or the baffle mould portions may be formed of one or more separate components that can be suitably fixed to the cylindrical section. The hollow mould elements may be formed of a substantially steel frame.

A first fibrous material is held by suitable fastening means, e.g. a suitable fastening arrangement, to an internal surface of each of the hollow mould elements. In the present example, a ceramic fibre is used. A suitable adhesive is then applied to an outer surface of the first fibrous material. This is followed by securing a second fibrous material in position on top of the first fibrous material 160. In the present example, a polymeric fibre is used. Whilst two fibrous materials have been applied to the internal surface of each hollow mould element, it will be appreciated by a person skilled in the art that one or more fibrous materials could be used during this stage of the process.

Further, the two mentioned fibrous materials are to be taken as only exemplary, as alternative fibrous materials may be employed in this process. Whilst it is not necessary to have the same arrangement and type of fibrous material applied to each hollow mould element, it is preferable in the formation of a homogenous and consistent hollow composite vessel.

Once each of the hollow mould elements have been prepared, the hollow mould elements are suitably assembled and fixed together to form the whole hollow composite vessel mould. The assembled mould is then inserted into the rotational moulding apparatus.

An example was demonstrated by placing about 350 kg of polyethylene powder into the rotational moulding apparatus prior to its closure. Gas pressure is used to hold the fibrous material layers to the internal surface of the hollow mould whilst the assembled mould was undergoing rotation and conventional rotational mould heating. This is achieved by supplying a gas flow into an interior of the rotational moulding apparatus, thereby applying a pressure differential across the fibrous materials to force the fibrous materials against the internal surface of assembled mould.

Throughout the duration of the rotational moulding process, various rotational moulding parameters are considered and varied throughout the process to produce a suitable hollow composite vessel. These parameters include:

### Mould Temperature and Methods of Heating;

Rotational speed (about longitudinal axis) of rotational mould apparatus;
Tilt speed (about transverse axis) of rotational mould apparatus;
Tilt angle—maximum angle reached relative to longitudinal axis through rotation of mould apparatus about the transverse axis;
Pressure—pressure inside mould to help hold the fibrous layers to the internal surface of the mould and to maintain contact between the melted polyethylene and the fibrous layers; and
Timing—how long to hold certain parameters.

Throughout the process, care is taken in adjusting the rotational moulder apparatus set temperature, mould temperatures, and the pressure to ensure that a suitable ‘lay-up’ of polyethylene is established on the internal surface of the assembled mould, particularly at the baffle structures. As mentioned previously, the shaping of the baffle structures have been carefully designed to ensure that contact time between the polyethylene and the baffle structure is sufficient to produce moulded baffles of suitable structural integrity in the produced hollow composite vessel.

Once the polyethylene has been suitably melted and dispersed, the rotational moulder apparatus set temperature and mould temperature are reduced and then ultimately the heating turned off to allow the mould to cool so that the polyethylene solidifies. Once the temperature measured inside the mould is suitably low (and well below the melting point of the polyethylene powder), pressure is released via an outlet valve. Towards the end of the process, rotation of the rotational mould apparatus about both longitudinal and transverse axes is halted. A hollow thermoplastic polymer/fibrous material composite vessel having structure (e.g. baffles) protruding into an interior of the vessel can then be released from the mould.

A thickness gauge was used to check the thickness of the produced thermoplastic polymer/fibrous material composite vessel and an exterior examination indicated that the fibrous layers were strongly affixed to the polyethylene by partial, but not complete, wet through of the polyethylene into the fibrous layers. Visual interior examination indicated that the inner polyethylene layer was of sufficient thickness throughout, and that there were no obvious thin spots.

A second example was demonstrated by placing about 225 kg of polyethylene powder into the rotational moulding apparatus prior to its closure. The earlier steps of preparing the hollow mould are as per the first trial run. Similar to the first trial run, throughout the duration of the rotational moulding process, various rotational moulding parameters are varied throughout the process to produce a suitable hollow composite vessel. As will be appreciated by a person skilled in the art, given the significantly lower quantity of polyethylene powder used in the second trial run, most of the hold times for the temperature and pressure parameters would be reduced. The temperature and pressures employed were otherwise similar to those employed in the first trial run.

A thickness gauge was again used to check the thickness of the produced thermoplastic polymer/fibrous material composite vessel and an exterior examination indicated that the fibrous layers were strongly affixed to the polyethylene by partial, but not complete, wet through of the polyethylene into the fibrous layers. Visual interior examination indicated that the inner polyethylene layer was of sufficient thickness throughout, although there was some appearance of thin spots.

The next stage of the process involves the baffle structure being reinforced. In the present embodiment, this is achieved by inserting reinforcement into the cavities formed in the outer wall of the hollow thermoplastic polymer/fibrous material composite vessel. It will be appreciated however that in other embodiments, although not desired, the baffle structure can be reinforced from inside the vessel. There are many possible ways in which the cavities can be suitably reinforced to meet the load requirements of the hollow composite vessel, e.g. in particular surge forces experienced by the vessel 10 or any structure to which the vessel 10 is affixed in use.

In the present embodiment, a structural skin formed of an intermediate strength carbon fibre reinforced polymer and core sandwich is wet laid into the cavity. In addition to the structural skin, further reinforcement is provided by inserting bracing structure into the cavity. The bracing structure includes a plurality of bracing elements, each made of wet-laid standard strength carbon fibre reinforced polymer, that is fixed to the structural skin using a suitable adhesive (e.g. a synthetic resin such as a thermoset adhesive).

The hollow thermoplastic polymer/fibrous material composite vessel is then reinforced by applying a plurality of filaments selected from one or more of carbon, glass, aramid and basalt filaments to the outside of the hollow thermoplastic polymer/fibrous material composite vessel wherein prior to application the plurality of filaments are at least partly wetted with one or more thermosetting polymers. Thus, a hollow composite vessel is formed having increased strength and stiffness. The fibrous layer of the hollow thermoplastic polymer/fibrous material composite vessel facilitates coupling of the reinforcement layer thereto, thus resulting in the fibrous materials being at least partly infiltrated with both the one or more thermoplastic polymers and the one or more thermosetting polymers.

It will be understood that the invention disclosed and defined in this specification extends to all alternative combinations of two or more of the individual features mentioned or evident from the text or drawings. All of these different combinations constitute various alternative aspects of the invention.

1. A hollow roto-moulded article, having an inner wall defining an interior of the article and integrally formed structure with the inner wall, wherein the integrally formed structure protrudes into the interior of the article, the article formed of a first layer including one or more thermoplastic polymers, and a second layer including one or more fibrous materials.

2. The hollow roto-moulded article of claim 1, wherein the one or more fibrous materials is at least partly infiltrated with the one or more thermoplastic polymers.

3. The hollow roto-moulded article of claim 1 or 2, wherein the article includes at least one cavity extending towards the interior of the article, wherein the cavity includes an internal surface profile that substantially corresponds to an external surface profile of the integrally formed structure.

4. The hollow roto-moulded article of claim 3, wherein the article includes a recess disposed about a periphery of the at least one cavity, wherein the recess is configured to facilitate engagement of one or more subsequent layers to the first and second layers.

5. The hollow roto-moulded article of claim 3 or 4, further including reinforcement disposed in the at least one cavity, wherein the reinforcement is configured to stiffen and/or strengthen at least a portion of the integrally formed structure.

6. The hollow roto-moulded article of claim 5, wherein the reinforcement includes a structural skin fixed in the at least one cavity.

7. The hollow roto-moulded article of claim 5 or 6, wherein the reinforcement includes bracing structure adapted to be connected in the at least one cavity, the bracing structure including a plurality of bracing elements fixed in the cavity and arranged to stiffen and/or strengthen the integrally formed structure.

8. The hollow roto-moulded article of claim 7, wherein the bracing elements are of substantially beam-like form and are arranged in a substantially lattice framework.

9. The hollow roto-moulded article of claim 7 or 8 insofar as dependent on claim 6, wherein the bracing structure is fixed to the structural skin.

10. The hollow roto-moulded article of any one of the preceding claims, wherein the integrally formed structure protruding into the interior of the article is one or more baffles.

11. The hollow roto-moulded article of claim 10, wherein the one or more baffles are arranged to extend in a direction substantially parallel to a longitudinal axis of the article.

12. The hollow roto-moulded article of claim 10, wherein the one or more baffles are arranged to extend in a direction substantially perpendicular to a longitudinal axis of the article.

13. The hollow roto-moulded article of claim 12, wherein a pair of baffles extend into the interior of the article from substantially opposed locations of the inner wall and form a gap therebetween.

14. The hollow roto-moulded article of claim 13, wherein the gap is substantially V-shaped when the article is viewed in transverse cross-section, wherein a narrower end of the V-shaped gap is disposed at a lower end of the article, and a wider end of the V-shaped gap is disposed at an upper end of the article.

15. The hollow roto-moulded article of any one of claims 10 to 14, wherein the or each baffle includes a first baffle wall and a second baffle wall each extending from the inner wall of the article into the interior of the article and merging into a baffle tip.

16. The hollow roto-moulded article of claim 15, wherein the first and second baffle walls are angled towards one another, thereby defining a substantially U-shaped baffle when the baffle is viewed in transverse cross section.

17. The hollow roto-moulded article of claim 15 or 16, wherein the or each baffle includes a tip transition portion between the first baffle wall and the baffle tip and between the second baffle wall and the baffle tip, wherein the tip transition portions are substantially curved, thereby defining a smooth transition profile between the first baffle wall and the baffle tip and between the second baffle wall and the baffle tip.

18. The hollow roto-moulded article of claim 17, wherein a radius of curvature of the tip transition portions is in the range of about 2 mm to about 500 mm.

19. The hollow roto-moulded article of any one of claims 15 to 18, wherein the article includes substantially curved base transition portions between the inner wall and the first baffle wall and between the inner wall and the second baffle wall.

20. The hollow roto-moulded article of any one of claims 15 to 19, wherein an external surface profile of the or each baffle is substantially continuous with the inner wall, thereby providing seamless transition between the inner wall of the article, the first wall, the second wall and the baffle tip.

21. The hollow roto-moulded article of any one of the preceding claims, wherein the one or more thermoplastic polymers in the first layer include one or more of ethylene homopolymers, ethylene co-polymers, propylene homopolymers, propylene co-polymers, fluoropolymers, polyvinylchloride, polyvinylidene chloride, polyaryl ether ketone and polyamide.

22. The hollow roto-moulded article of any one of the preceding claims, wherein the one or more fibrous materials in the second layer include one or more of glass fibre, carbon fibre and basalt fibres, or precursors thereof.

23. The hollow roto-moulded article of any one of the preceding claims, wherein the article includes a third layer including a plurality of filaments selected from one or more of carbon, glass, aramid and basalt filaments, and one or more thermosetting polymers, wherein the second layer is disposed between the first layer and the third layer, and wherein the one or more fibrous materials is at least partly infiltrated with both the one or more thermoplastic polymers and the one or more thermosetting polymers.

24. The hollow roto-moulded article of claim 23, wherein the one or more thermosetting polymers of the third layer comprise one or more of vinyl ester, bismaleimide, polyester, polyacrylate, epoxy, and polyurethane.

25. The hollow roto-moulded article of any of the preceding claims, wherein the article is a hollow composite vessel, and the integral structure is configured to reduce surge forces experienced by the hollow composite vessel in use.

26. A method of producing a hollow composite vessel, the method including:
applying one or more fibrous materials to an internal surface of a hollow mould, the hollow mould including structure protruding into an interior of the mould;
heating and rotating the hollow mould in the presence of one or more thermoplastic polymers within the hollow mould so that the polymer melts and at least partially infiltrates the fibrous material;
cooling the mould so that the thermoplastic polymer solidifies; and
releasing a hollow thermoplastic polymer/fibrous material composite vessel having integrally formed structure protruding into an interior of the vessel from the mould.

27. The method of claim 26, further including reinforcing the integrally formed structure before applying additional layer(s) to the hollow thermoplastic polymer/fibrous material composite vessel.

28. The method of claim 26, further including one or more of the following:
applying a plurality of filaments selected from one or more of carbon, glass, aramid and basalt filaments to the outside of the hollow thermoplastic polymer/fibrous material composite vessel wherein prior to application the plurality of filaments are at least partly wetted with one or more thermosetting polymers;
applying a plurality of filaments selected from one or more of carbon, glass, aramid and basalt filaments to the outside of the hollow thermoplastic polymer/fibrous material composite vessel followed by application of one or more thermosetting polymers;
applying one or more thermosetting polymers to the outside of the hollow thermoplastic polymer/fibrous material composite vessel followed by application of a plurality of filaments selected from one or more of carbon, glass, aramid and basalt filaments.

29. The method of claim 27, wherein the one or more thermosetting polymers include one or more of vinyl ester, bismaleimide, polyester, polyacrylate, epoxy, and polyurethane.

30. The method of any one of claims 26 to 28, wherein applying one or more fibrous materials to an internal surface of a hollow mould includes applying one or more of glass fibre, carbon fibre and basalt fibres, or precursors thereof.

31. The method of any one of claims 26 to 29, wherein the one or more thermoplastic polymers include one or more of ethylene homopolymers, ethylene co-polymers, propylene homopolymers, propylene co-polymers, fluoropolymers, polyvinylchloride, polyvinylidene chloride, polyaryl ether ketone and polyamide.

32. The method of any one claims 26 to 30, wherein the structure of the hollow mould protruding into the interior of the mould is one or more baffle mould portions each adapted to produce a cavity of substantially the same form in the hollow thermoplastic polymer/fibrous material composite vessel.

33. The method of claim 32, further including reinforcing the integrally formed structure by inserting reinforcement into each cavity.

34. The method of claim 33, wherein reinforcing the integrally formed structure includes inserting a structural skin into each cavity.

35. The method of claim 33 or 34, wherein reinforcing the integrally formed structure includes inserting bracing structure into each cavity, wherein the bracing structure includes a plurality of bracing elements fixed in the cavity and arranged to stiffen and/or strengthen the integrally formed structure.

36. The method of any one of claims 26 or 35, wherein the hollow mould further includes a protrusion disposed about a periphery of the structure protruding into an interior of the mould, wherein the hollow thermoplastic polymer/fibrous material composite vessel thereby includes a recess extending through the outer wall of the thermoplastic polymer/fibrous material composite, the recess disposed about a periphery of the cavity.
